(19) United States
(12) Patent Application Publication
(10) Pub. No.: US 2024/0392209 A1
(43) Pub. Date: Nov. 28, 2024

(54) PROCESS FOR PROVIDING HYDROGENATED OILS AND/OR FATS

(71) Applicant: GEA WESTFALIA SEPARATOR GROUP GMBH, Oelde (DE)

(72) Inventors: Abel Fernandes CAMPOS, Gütersloh (DE); Barbara HARTEN, Oelde (DE); Dirk SINDERMANN, Oelde (DE)

(21) Appl. No.: 18/688,409

(22) PCT Filed: Sep. 1, 2022
(86) PCT No.: PCT/EP2022/074378

§ 371 Date: Mar. 1, 2024

(30) Foreign Application Priority Data
Sep. 2, 2021 (DE) 10 2021 122 726.7

(51) Int. Cl. C11C 3/12; C11C 1/08

(52) U.S. Cl. CPC C11C 3/12; C11C 1/08

(57) ABSTRACT

A process for providing hydrogenated oils and/or fats involves providing a fat fraction and/or oil fraction having a phosphorus content of more than 3.0 mg/kg and/or a total metal content of more than 5.0 mg/kg. The fat fraction and/or oil fraction is washed with an organic acid and optionally a demulsifier by stirring to form a heterogeneous mixture. The mixture is centrifugally separated to form a high-water and low-oil and/or -fat phase and a low-water and high-oil and/or -fat phase having a phosphorus content of less than 3.0 mg/kg and a total metal content of less than 5.0 mg/kg. The low-water and high-oil and/or -fat phase is dried. The dried high-oil and/or -fat phase is catalytically hydrogenated. The proportion of water metered in during the performance of the process is less than 5% by weight, based on the weight of the fat fraction and/or oil fraction.

### BACKGROUND AND SUMMARY OF THE INVENTION

Exemplary embodiments of the present invention relate to the purification of oils and/or tats, preferably derived from vegetable oils and animal fats, prior to the hydrogenation of these oils and/or fats in order to achieve a phosphorus content of below 3.0 mg/kg and a total metal content of below 5 mg/kg prior to hydrogenation.

Special heterogeneous catalysts are used in the process for producing hydrogenated vegetable oils (HVO). These can be deactivated by phosphorus and metals contained in the raw material.

Elements such as phosphorus have a negative effect in the hydrogenation process of fats and/or oils, the so-called HVO process. This affects the agglomeration, as well as surface and pore coating of the catalysts. These lead to increased pressure loss in the fixed bed reactor. The consequence is a non-conversion of the raw material and a shortening of the catalyst change intervals.

In order to reduce the phosphorus content and other elements, acid degumming with integrated washing is traditionally used in edible oil refineries. The oil is subsequently filtered with special bleaching earths.

It was found that the combination of acid degumming, washing, and bleaching can improve the purification or reduction of phosphorus and total metals to a certain extent. However, for certain raw materials, especially for animal fats of categories 1 and 2 according to Regulation (EC) No. 1069/2009, high operational costs for the bleaching process are to be expected.

Special bleaching earths are used in such a bleaching process, which make a considerable contribution to the operating costs. Significant purchase prices and high disposal costs must be expected. In addition, greater precautions must be taken for the temporary storage of waste bleaching earths, as these can easily self-ignite. In addition, the greenhouse gas value (GHG value) will increase with each additional process stage.

One approach to process optimization is disclosed in EP 3 494 201 A1. Here, an inorganic acid such as phosphoric acid or sulphuric acid is used to reduce the phosphorus and the total metals. Furthermore, process temperatures of 200° C. to 280° C. are required, as well as the addition of up to 10% by weight of water. The process therefore requires an increased energy input and produces a water fraction that is difficult to process.

EP 3 666 864 A1 discloses the use of an organic or inorganic acid at a temperature between 140° C. and 195° C., as well as the addition of water at a ratio of 1:5 to 5:1 (oil:water). EP 3 666 866 A1 describes a two-stage process for the reduction of total metals and phosphorus in a fat and/or oil phase. In the first stage of the process, the total metals are reduced using organic or inorganic acids at a temperature between 95° C. and 140° C. and the addition of water in a ratio of 1:5 to 5:1 (oil:water). In a second process stage, organic or inorganic acids are used to reduce phosphorus and residual metals at a temperature of between 150° C. and 210° C. and water is added in a ratio of 1:5 to 5:1 (oil:water).

The processes described in EP 3 494 201 A1, EP 3 666 864 A1 and EP 3 666 866 A1 can reduce operating costs, safety precautions and GHG emissions compared to the conventional variant of treatment with bleaching earth. However, an increased amount of waste water is produced in these processes.

Based on this preliminary consideration, exemplary embodiments of the present invention are directed to further improving the pretreatment stage or the purification of the raw material prior to its conversion in the course of hydrogenation.

The process according to the invention is used to provide hydrogenated oils and/or fats, wherein the method comprises at least the following steps of:
A providing a fat fraction and/or oil fraction having a phosphorus content of more than 3.0 mg/kg and a total metal content of more than 5.0 mg/kg;
B high-temperature washing of the fat fraction and/or oil fraction from A with an organic acid and preferably the addition of one or more demulsifiers by stirring to form a heterogeneous mixture;
C centrifugally separating the mixture from B to form a water-rich and oil- and/or fat-poor heavy phase and a low-water and oil-rich and/or fat-rich light phase having a phosphorus content of less than 3.0 mg/kg;
D drying of the low-water and oil-rich and/or fat-rich phase from C, and
E hydrogenating, in particular catalytically hydrogenating, the dried oil-rich and/or fat-rich phase from D.

According to the invention, the proportion of water metered in during performance of the process is in the range of less than 5% by weight, based on the weight of the fat fraction and/or oil fraction.

The proportion of water metered in is primarily determined by the proportion of water in the added organic acid. Overall, this process produces significantly lower quantities of waste water than the aforementioned prior art processes.

Preferably, the total water content of the mixture separated in step C can be less than 3.5% by weight, preferably between 0.5-2.5% by weight based on the weight of the fat fraction and/or oil fraction. The total water content comprises the water content of added water, for example by adding organic dilute acid, but also the water content in the raw materials, which is preferably not more than 1.5% by weight.

The washing in step B preferably only comprises a supply of organic acid, optionally the demulsifier and optionally also water. An aqueous fraction is only removed during separation in step C.

In particular, the subject matter of the present invention is also applicable to raw materials, i.e., 1st and/or 2nd generation oils and/or fats, wherein the phosphorus content of these raw materials is more than 3 mg/kg and the total metal content is more than 5 mg/kg and the raw materials would therefore actually be harmful to the catalyst during hydrogenation.

Surprisingly, it was found that a phosphorus content of less than 3 mg/kg and a total metal content of less than 5 mg/kg, which corresponds to the requirements for the raw material for an HVO plant, can be achieved with a very simple pre-treatment at low waste water volumes.

It was also found that the centrifugal separation in step C can be significantly improved by adding a demulsifier. This can be added directly before step C. However, an addition in the high-temperature washing, i.e., in step B, is preferable.

Emulsions can be strongly affected by phospholipids, metals, monoglycerides, diglycerides, free fatty acids or their combination, which are contained in the fat/oil, together with the addition of water, the reaction or high-temperature washing. This leads to a minimization of the quality of the purified fat/oil, as the microemulsion in the oil phase adsorbs some of the phospholipids.

Phospholipids have a polar group (phosphate) and a non-polar group (diglycerides). At higher temperatures, above 180° C., phospholipids can be split into polar and non-polar groups. The cleavage is catalyzed by the addition of dilute acid. Without the addition of a demulsifier, cleavage is more difficult at high temperatures, as the microemulsions form a stable phase. Some of the phospholipids cannot be split into polar and non-polar groups and remain in the oil phase. The consequence is an increased phosphorus content in the oil phase.

Preferably, the proportion of demulsifier metered in during the performance of the process is in the range of less than 1000 mg/kg based on the weight of the fat fraction and/or oil fraction. Preferably, it should be between 10-500 mg/kg, based on the weight of the fat fraction and/or oil fraction.

A demulsifier is preferably a mixture of polymers and surfactants. Heat-stable demulsifiers that only decompose at a temperature above 200° C. are preferred.

The process according to the present invention also has further advantages over individual processes of the prior art. For example, an advantage results from the use of a process temperature of less than 190° C. In contrast to EP 3 494 201 A1, less heating medium and lower process pressure is used, which has a favorable effect on the ongoing operating costs.

In contrast to EP 3 494 201 A1, an organic acid such as citric acid is used. The advantage of an organic acid in general, and citric acid in particular, over sulphuric acid is that it is less corrosive. In addition, no sulphates need to be treated from the waste water. The advantage of citric acid over phosphoric acid is the lower probability of phosphorus contamination in the purified product.

In contrast to EP 3 666 864 A1, a lower total water addition is used for the phosphorus reduction process stage, up to 5.0% by weight, i.e., in a ratio of 4.75:0.25 (oil:water). With the addition of demulsifier during high-temperature washing, phosphorus values of no more than 3 mg/kg are achieved.

In contrast to EP 3 666 866 A1, in the present invention a high-temperature wash can be realized first and, optionally, a second wash can be carried out at a lower temperature. Moreover, an advantage of the present invention over EP 3 666 866 A1 is that in a two-stage process a lower proportion of total water—e.g., up to 10.0% by weight—is added, i.e., in a ratio of 4.5:0.5 (oil:water). With the addition of one or more demulsifiers during the high-temperature wash, phosphorus values of no more than 3 mg/kg are preferably achieved. This eliminates the need for a second wash at low temperature.

This results in less waste water and lower operating costs, as less total volume circulates in the system, which contributes to lower overall heating costs and waste water volumes. The acquisition costs can also be reduced as the system components are smaller.

The raw materials as fat fraction and/or oil fraction in step A may comprise a fat or oil of a vegetable and/or animal origin, in particular rapeseed oil, soybean oil, palm oil, sunflower oil, corn oil, coconut oil, palm olein, oil obtained from palm oil mill effluent, used cooking oil, animal fat, fatty acids, yellow fat, brown fat, algae oil, tall oil, jatropha oil, bacterial oil, insect fat, fish oil and/or oil obtained from used bleaching earths.

Various raw materials can be used for fat and/or oil hydrogenation. However, in order to reduce greenhouse gas emissions (GHG), waste materials, also known as 2nd generation raw materials, are increasingly being used, such as used cooking oils (UCO/WCO, Used/Waste Cooking Oil), animal fats (e.g., EU: Category 1 (Cat1) and Category 2 (Cat2), USA: SRM (Specified Risk Material), inedible lard or tallow, brown and yellow grease), or chemically cleaved fatty acids from soap splitting.

1st generation raw materials relate to oil plants such as: Rapeseed oil, soybean oil, palm oil, sunflower oil, or other oil plants. These raw materials are to be limited in Europe with the Renewable Energy Directive (RED) and in the USA, primarily in California, and Canada with Low Carbon Fuel Standard (LCFS) initiatives.

A particularly preferred raw material in the context of the present invention is the so-called “Palm Oil Mill Effluent”, also known as POME for short.

In order to reduce the contamination of the raw material before use in an HVO plant and thus protect the catalyst from unexpected deactivation, the raw materials should be pre-treated. Table 1 shows typical phosphorus and total metal values that can be found in crude oil.

TABLE 1

| Phosphorus | Total metals |
|---|---|
| (mg/kg) | (mg/kg) |
| 5-2000 | 10-2000 |

The total metals include the alkali metals, alkaline earth metals, metals, and semi-metals from the periodic table.

In addition to the fats and/or oils of vegetable or animal origin, the fat fraction and/or oil fraction in step A may also comprise a pyrolysis oil and/or oil obtained from sewage sludge.

The fat fraction and/or oil fraction may particularly preferably have a phosphorus content of between 3 mg/kg and 2000 mg/kg, a total metal content of between 5 mg/kg and 2000 mg/kg and a water content of less than 1.5% by weight.

Washing may include the addition of acid and the addition of a demulsifier at a temperature between 40-100° C., preferably 60-95° C.

The washing can also include hot mixing at a temperature in the range of 130° C. to 190° C. The mixture can be transferred to a separate tank or reactor and the mixing can be intensified under hot temperatures.

At least the addition of acid and demulsifier can be carried out using a dynamic mixer with adjustable speed.

The mixture of aqueous organic acid, demulsifier and the fat fraction and/or oil fraction can be transferred from the dynamic mixer to a reactor for hot mixing after the acid has been added.

Hot mixing can take place at a process pressure of 0 to 5 bar overpressure, preferably 0.5 to 2 bar. This facilitates the phase transition of the components to be washed out.

In order to ensure better transfer of the phosphorus compounds into the aqueous phase, a retention time of 5 to 90 minutes is recommended for hot mixing.

The hot mixing of the aqueous organic acid and the demulsifier with the fat fraction and/or oil fraction can be carried out particularly efficiently using an agitator at a speed in the range of 25 revolutions per minute (rpm) to 120 rpm.

The total metal content of the purified fat fraction and/or oil fraction prior to hydrogenation in step E may be less than 5.0 mg/kg.

The process for reducing the phosphorus content to less than 3 mg/kg and the total metal content to less than 5 mg/kg can be carried out optimally and in an energy-saving manner with just a single washing stage.

However, if the initial concentrations are too high or the oil or fat compounds are unfavorable, steps B and C can also be carried out at least a second time. Steps B and C are preferably repeated only once.

If repeated, step B can be carried out in an energy-efficient manner without additional hot mixing. Furthermore, the temperature of the wash is less than 100° C.

The proportion of the aqueous acid solution in the mixture after the acid has been added can be in the range of 0.5% to 5.0% by weight, based on the weight of the fat fraction and/or oil fraction.

The proportion of concentrated organic acid after the acid has been added to the mixture can advantageously be in the range from 0.01% to 0.50% by weight in relation to the fat/oil mass flow. In the context of the present invention, concentrated organic acid is defined as 100% acid. The aforementioned aqueous acid solution is thus an acid diluted with water, in particular deionized water.

Citric acid, preferably in diluted form, can be used as the organic acid.

The proportion of demulsifier can advantageously be in the range of 10 mg/kg to 500 mg/kg in relation to the fat/oil mass flow. Heat-stable demulsifiers that only decompose at a temperature above 200° C. are preferred.

The drying in step D of the separated light phase (fat/oil) from the liquid-liquid separation device can preferably be carried out under vacuum.

### BRIEF DESCRIPTION OF THE SOLE DRAWING

The present invention is explained in more detail below by means of an exemplary embodiment with the aid of the accompanying FIGURE, wherein:

The sole drawing shows a block diagram of a process schematic of an embodiment variant of the process according to the invention.

### DETAILED DESCRIPTION

The sole drawing shows an embodiment variant of a process according to the invention. A first process step is the provision of a starting material.

The starting material is a fat fraction and/or oil fraction 1. This fat fraction and/or oil fraction has a phosphorus content of greater than 3 mg/kg and/or a total metal content of greater than 5 mg/kg. The water content of this fat fraction and/or oil fraction is preferably less than 1.5% by weight. The total metal content comprises the total of the concentrations of dissolved and undissolved metal ions in the mixture.

In a second process step, an organic acid and demulsifier 2 are added to the fat fraction and/or oil fraction 1 as part of a first wash 3. Preferably, citric acid and a heat-stable demulsifier can be used as the organic acid. Such a demulsifier can be, for example, an oleic acid derivative which is both lipophilic and hydrophilic. In said oleic acid derivative, the terminal carboxy group may in particular be substituted by an imidazole group.

The substitution can take place with water cleavage with intermediate formation of an amide, wherein the heterocyclic imidazole group is subsequently formed by further water cleavage.

The proportion of demulsifier (2) in the heterogeneous mixture can preferably be in the range of 1 mg/kg to 1,000 mg/kg in relation to the fat/oil mass flow. In particular, the amount of demulsifier added is such that the proportion of demulsifier in the heterogeneous mixture is between 5-500 ppm, preferably between 100-250 ppm.

The addition of the demulsifier before and/or during and/or immediately after hot mixing and before centrifugal separation enables particularly efficient splitting of the phospholipids into phosphates and triglycerides.

In this wash 3, the organic acid 2 can be used as an acid solution diluted with water, in particular with demineralized water. The proportion of water in the added organic acid solution is preferably between 1.0% and 5.0% by weight, preferably 2.5% by weight (+/−0.2% by weight) based on the weight proportion of the fat fraction and/or oil fraction. The addition of demulsifier is between 10 mg/kg to 500 mg/kg in relation to the fat/oil mass flow. The preferred temperature of the fat fraction and/or oil fraction 1 during wash 3 is between 60° C. and 95° C. Intensive mixing takes place with the organic acid and the demulsifier 2 as an acid solution with a fat fraction and/or oil fraction. The stirring speed in this step can be more than 500 rpm. For intensive mixing, a dynamic mixer is preferably used in the context of the present invention.

The concentration of the added acid solution varies between 0.01% by weight and 0.35% by weight based on 100% by weight organic acid in relation to the amount of fat fraction and/or oil fraction.

The mixture from the dynamic mixer is heated to a temperature in the range of 100° C. to 190° C. and fed to a reactor 4 under overpressure conditions. The pressures in reactor 4 are up to 5 bar, preferably up to 2 bar overpressure. The retention time in reactor 4 varies from 30 to 90 minutes, preferably between 45 and 60 minutes under constant stirring at a stirrer speed of 25 rpm to 120 rpm. The overpressure treatment at elevated temperatures is referred to as hot mixing 4a. This hot mixing is part of wash 3.

In order to achieve a particularly optimized reduction in the water content, the hot wash in reactor 4 is adjusted by regulating the process pressure. For this purpose, the reactor 4 has a pressure sensor for pressure measurement 14. The outlet of the reactor 4 has a regulating valve for pressure regulation 15. Not shown is a control and/or evaluation unit that controls the regulating valve for pressure regulation based on the measured values determined by the pressure sensor for pressure measurement.

The process pressure that prevails during hot washing is thus set to a preferred range between 0-5 bar, preferably 0.5 to 2 bar overpressure.

The mixture coming out of the reactor 4 is cooled to a temperature in the range of 60° C. to 95° C. and fed to a self-cleaning disk centrifuge 5. Separation 5a of the mixture as the third process step at the above-mentioned temperature takes place at more than 5000 G, preferably between 6000-12000 G. A heavy water-rich and low-oil and/or low-fat phase 6 and a light oil-rich and/or fat-rich and low-water phase 7, hereinafter also referred to as the purified fat and/or oil phase, are discharged from the centrifuge.

The heavy phase 6 essentially contains the water, acid, phosphorus, metal compounds, nitrogen compounds and small amounts of fat/oil. The light phase 7 comprises the main proportion of oils and/or fats from the mixture supplied. The phases are discharged separately from the disk centrifuge 5.

An acid-resistant design is preferred for the disk centrifuge 5. The disk centrifuge preferably has a gripper for discharging the light phase. The feed and discharge volumes are set in such a way that the light phase is removed from the disk centrifuge 5 under overpressure. The overpressure can be the same as for hot washing.

Particularly preferably, the heavy phase can also be removed under overpressure. Here too, the overpressure can be the same as for hot washing. For example, both phases can be removed under overpressure by the disk centrifuge 5 in the form of a double-gripper disk centrifuge.

For particularly efficient separation of water from the fat and/or oil phase, a speed of 3000-5000 rpm is recommended, in particular 4000-4500 rpm.

The purified fat and/or oil phase 7 has a phosphorus content of less than 3.0 mg/kg. It can also have a reduced total metal content of less than 5.0 mg/kg. This corresponds to a phosphorus and metal compound content reduced by at least 50%, preferably more than 90%, compared to the starting material.

If the purified fat and/or oil phase after the first wash 3 and separation 5a contains a total metal content of more than 5 mg/kg, the fat and/or oil phase should be purified again with a second wash 8. The second wash can be carried out at a lower temperature than the first wash 3. The second wash 8 follows in order to reduce the total metal content even further.

The purified fat and/or oil phase 7 coming from the disk centrifuge 5 has a temperature in the range of 60° C. to 95° C. and is again intensively mixed with the acid solution 2 in the second wash, at a temperature between 60° C. to 95° C., diluted in demineralized water 6 of 1.0% by weight to 5.0% by weight, preferably 3.0% by weight (+/−0.2% by weight) based on the amount of fat/oil. This is also an organic acid, in particular the same acid as in the first wash. A dynamic mixer is again preferred for mixing. The concentration of the acid solution varies between 0.01% by weight and 0.35% by weight based on a 100% by weight organic acid in relation to the fat/oil quantity.

Immediately after mixing and after a short run-in time of between 1 and 3 minutes, the mixture can be fed to a disk centrifuge for separation 9 and a further purified low-water fat and oil phase 10 can be obtained.

As the final stage of the process, the purified fat and/or oil phase 7 can be fed to a drying stage 11, preferably in a dryer operated under vacuum, in order to reduce the moisture content of the finished product 12.

The finished product 12 is then subjected to a catalytic hydrogenation 13 known per se.

The purified and essentially anhydrous fat and/or oil phase with a phosphorus content below 3.0 mg/kg and a total metal content below 5.0 mg/kg can now be stored and does not require any further bleaching stage to reduce the phosphorus or total metal content.

For a better understanding of the invention, here are some examples:

### Example 1

Animal fat cat 1 with a phosphorus content greater than 3 mg/kg and a total metal content greater than 5 mg/kg was treated with a high temperature wash as described previously for wash 3. The analyzed data are listed in Table 2 below.

TABLE 2

| | | Without | |
|---|---|---|---|
| | | demulsifier | With demulsifier |
| | | after | after |
| | Raw fat | first wash | first wash |
| Analyzes | (mg/kg) | (mg/kg) | (mg/kg) |
| Phosphorus | 17.3 | 6.3 | 1.3 |
| Total metals | 118.5 | 14.3 | 4.8 |

As can be seen from Table 2, phosphorus was reduced to less than 3 mg/kg and total metals to less than 5 mg/kg.

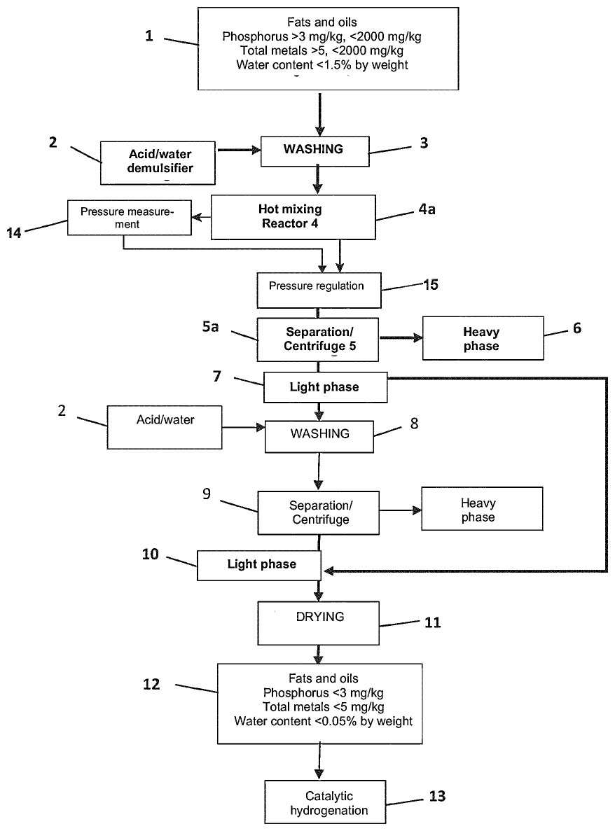

FIG. 1 summarizes in schematic form a variant of the process according to the invention, consisting of two washing stages with subsequent centrifugal separation of the water phase and a drying stage. However, a single-stage washing process is sufficient for most fats/oils.

An appropriate liquid-liquid separation device for carrying out the process may comprise a settling tank, a centrifuge, a separator, or a combination of the foregoing.

The process can be carried out in batch mode or in continuous mode.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the FIGURES enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 Fat fraction and/or oil fraction
2 Organic acid and demulsifier
3 Wash
4 Reactor
4a Hot mixing
5 Centrifuge
5a Separation
6 Water-rich and low-oil and/or low-fat heavy phase
7 Low-water and oil-rich and/or fat-rich light phase
8 Wash
9 Separation
10 Purified low-water and oil-rich and/or fat-rich heavy phase
11 Drying stage
12 Dried oil-rich and/or fat-rich phase with optimized phosphorus and total metal content
13 Catalytic hydrogenation
14 Pressure measurement
15 Pressure regulation

1-22. (canceled)

23. A method for providing hydrogenated oils or fats, the method comprising:
A) providing a fat fraction or oil fraction having a phosphorus content of more than 3.0 mg/kg or having a total metal content of more than 5.0 mg/kg;
B) washing of the fat fraction or oil fraction from step A) with an organic acid by stirring to form a heterogeneous mixture;
C) centrifugally separating the mixture from step B) to form a water-rich and low-oil or low-fat heavy phase and a low-water oil-rich or fat-rich light phase having a phosphorus content of less than 3.0 mg/kg;
D) drying the low-water and oil-rich or fat-rich phase from step C); and
E) catalytically hydrogenating the dried oil-rich or fat-rich phase from step D),
wherein a proportion of water metered-in during the method is less than 5% by weight, based on the weight of the fat fraction or oil fraction, and
wherein a demulsifier is added during the washing in step B) or at least before step C).

24. The method of claim 23, wherein the fat fraction or oil fraction in step A) comprises a fat or oil of vegetable or animal origin.

25. The method of claim 23, wherein the fat fraction or oil fraction in step A) comprises a pyrolysis oil or oil obtained from sewage sludge.

26. The method of claim 23, wherein the fat fraction or oil fraction has a phosphorus content of between 3 mg/kg and 2000 mg/kg, a total metal content of between 5 mg/kg and 2000 mg/kg, and a water content of less than 1.5% by weight.

27. The method of claim 23, wherein the wash comprises adding the organic acid and demulsifier at a temperature between 40-100° C.

28. The method of claim 23, wherein the wash comprises hot mixing at a temperature in a range from 130° C. to 190° C.

29. The method of claim 23, wherein at least the addition of the organic acid and demulsifier is carried out by a dynamic mixer with adjustable speed.

30. The method of claim 23, wherein a mixture of the organic acid, the demulsifier, and the fat fraction or oil fraction is transferred from the dynamic mixer to a reactor after the addition of the organic acid and demulsifier for hot mixing.

31. The method of claim 30, wherein the hot mixing takes place at a process pressure of 0 to 5 bar overpressure, preferably 0.5 to 2 bar.

32. The method of claim 30, wherein a pressure measurement is performed out before or during the hot mixing in the reactor, and wherein the reactor has a regulating element that is set based on the pressure measurement.

33. The method of claim 30, wherein the hot mixing is carried out with a retention time of 5 to 90 minutes with constant stirring.

34. The method of claim 30, wherein the hot mixing is performed using an agitator at a speed in the range from 25 rpm to 120 rpm.

35. The method of claim 23, wherein a total metal content of the purified fat fraction or oil fraction prior to the hydrogenation in step E) is less than 5.0 mg/kg.

36. The method of claim 23, wherein the phosphorus content is reduced to less than 3 mg/kg and the total metal content is reduced to less than 5 mg/kg using only a single washing stage.

37. The method of claim 23, wherein steps B) and C) are performed at least a second time.

38. The method of claim 23, wherein a total water content of the mixture separated in step C) is less than 5% by weight based on a weight of the fat fraction or oil fraction.

39. The method of claim 23, wherein a proportion of concentrated organic acid in the mixture after the addition of the organic acid is in the range from 0.01% to 0.50% by weight in relation to the fat/oil mass flow.

40. The method of claim 23, wherein the organic acid is citric acid.

41. The method of claim 23, wherein a proportion of the demulsifier in the heterogeneous mixture is in a range from 1 mg/kg to 1,000 mg/kg in relation to fat/oil mass flow.

42. The method of claim 23, wherein the demulsifier is a heat-stable demulsifier that decomposes only at a temperature of greater than 200° C.

43. The method of claim 23, wherein the drying of the separated light phase from the liquid-liquid separation device in step D) is carried out under vacuum.
